(19) United States
(12) Patent Application Publication
(10) Pub. No.: US 2002/0065674 A1
(43) Pub. Date: May 30, 2002

(54) Calculation scale framework

(75) Inventor: Robert M. Dunn, Toronto (CA)

Correspondence Address: David A. Mims, Jr., IBM Corporation, Intellectual Property Law Dept., 11400 Burnet Road - Internal Zip 4054, Austin, TX, 78754, US

(73) Assignee: International Business Machines Coporation, Armonk, NY (US)

(21) Appl. No.: 09/918,576

(22) Filed: Jul. 31, 2001

(30) Foreign Application Priority Data
Nov. 30, 2000 (CA) 2,327,158

(51) Int. Cl. G06F 17/60

(52) U.S. Cl. 705/1

(57) ABSTRACT

The present invention provides a method of providing a reusable calculation scale framework. The reusable framework may be used in an electronic commerce environment. The electronic commerce environment defines a calculation rule and a set of commerce objects. Typically, the commerce objects are line items in invoices, purchase orders or other commercial documents or records generated in connection with web-based transactions. The method comprises steps of providing a calculation scale look up interface, a range look up result interface, a multiplication product of the results returned by the two interfaces, an apportioned monetary value for each of the commerce objects. The method is particularly useful in implementations for determining weighted shipping charges, discounts and taxes in various commercial environments. The environments may include a variety of calculation rules based on the circumstances in the commercial environment. The invention also provides a computer product for implementing the various methods. The computer product includes a recording medium such as a magnetic floppy disk, CD-ROM, hard drive or other suitable means. The products and methods are particularly useful in association with web-based commercial software applications. The methods and products provide a calculation scale framework which may be reused to avoid programming changes despite frequent, and often significant, changes in commercial environments.

### FIELD OF THE INVENTION

The invention relates to a method of providing a reusable use in association with various software applications in a commercial environment. The invention also provides an adaptable system to enhance performance of computer systems in a commercial environment, including web-based commercial systems.

### BACKGROUND OF THE INVENTION

Commerce systems are used to calculate monetary amounts including price discounts, shipping charges, and taxes, and then apply those calculated amounts to applicable objects such as invoice line items, or other objects. Business rules, legal requirements, tax legislation and other rules specify how and under what conditions these monetary amounts should be calculated. When the rules change, a good software commerce system will be easily adaptable to the changes with little or no programming changes.

Regrettably, commerce systems of the prior art have been limited in their applications and the scope of their uses. By way of example, software applications directed to invoicing, and other calculations used in connection with electronic commerce, including web-based applications, have been plagued with many limitations. In many instances, significant programming changes were necessary to implement minor changes within analogous environments. However, the present invention provides a framework for a reusable calculation scale which may be readapted for use in many diverse environments, often with little or no significant programming changes.

According to the present invention, many calculations have rules that can be formulated as a scale look up, where the scale is a list of range values and associated look up results. The advantages afforded by the methods and systems of the present invention will become more readily apparent to skilled persons in the art upon consideration of the more detailed descriptions provided within this specification.

With reference to the invention, it will be understood that the value that is used to perform the look up operation, and how the look up result becomes part of the calculation that is performed, depends on the kind of calculation being performed. The calculation scale result is a set of monetary amounts, one for each applicable object (such as, by way of example, an invoice line item in an e-commerce related calculation).

For example, a discount calculation rule may use the total amount being spent as a look up value into a table that specifies that amounts between $50 and $100 qualify for a $5 discount from the pretax purchase price, and that amounts of $100 or more qualify for a 10% discount. In another example, a shipping charge calculation rule may use the total shipping weight as a look up value into a table that specifies that amounts up to 10 lbs. incur a flat shipping charge of $2, and amounts more than 10 lbs. and over incur an additional shipping charge of $0.20 per lb. Or for example, a taxation calculation rule may specify that items whose unit price is less than $30 are exempt from tax, but items whose unit price is $30 or more are taxed at a 7% tax rate. A scale may be associated with a particular currency, or it may be necessary to produce calculation results in one of several currencies.

Commerce system programmers will be more productive if they can reuse a common framework of objects and methods to implement different kinds of calculation scales. They should be able to tailor the way the scale behaves, without having to reprogram the entire look up operation.

The calculation scale of the present invention as described further herein provides a generic framework that can be used to implement different kinds of calculation scales by varying methods that define how to look up a value in the scale, and how to use the look up result to determine a calculation result. The framework is flexible enough to handle a wide variety of business and legal requirements without programming, by choosing from a list of installed over-ridable method implementations. When business or legal requirements require a programming change, many such changes can be limited to programming additional over-ridable method implementations and installing them into the commerce system, without having to make any changes to existing programming.

### SUMMARY OF THE PRESENT INVENTION

This invention provides a general purpose framework of objects and methods that define calculation scales and provides programming interfaces that allow third party programmers to provide methods to control how look up values are determined, and how look up results are used to arrive at a calculation result.

In one aspect of the invention, a calculation scale is an object that has the following attributes:

a set of calculation range objects which are described in more detail below;

calculation usage—a generic indicator of the intended usage for the calculation code, such as discount, shipping charge, or tax calculation;

currency, if specified, it specifies the currency of the range start attributes of the scale's associated calculation range objects;

unit of measure—if specified, it specifies the unit of measure of the range start attributes of the scale's associated calculation range objects;

look up method—specifies a program that determines a look up value to be used with this calculation scale. The actual program that is called may be over ridden by a third party programmer, to implement different kinds of calculation rules.

In one aspect of the invention, a calculation range object has the following attributes:

range start—a number that specifies the starting value of a range in a scale;

cumulative—a flag that indicates whether the calculation results from all ranges with range start values less than the range's range start value should be added to the calculation result from this range;

range look up result method—specifies a program that determines a calculation result from a range look up result. The actual program that is called may be over ridden by a third party, to implement different kinds of calculation rules;

a set of one or more calculation range look up result objects (described in further detail below), none of which specify the same currency. If any in the set does not specify a currency, then there must be only one in the set.

A calculation range look up result object has the following attributes:

range look up result—a number that represents a range look up result to be passed to a range look up result method to determine a calculation result; and

currency—if specified, it specifies the currency of the range look up result. If both this currency and the currency of the calculation scale are specified, they must specify the same currency.

The calling interface to a calculation scale look up method is:

Input includes:

(1) A set of commerce objects, such as invoice line items, to which the calculation applies. Each commerce object has a currency, which must be the same for all commerce objects in the set. Each commerce object may also indicate information such as a product being purchased, its shipping weight, a unit price, a quantity (including a unit of measure), a unitless quantity (with no unit of measure), a gross price (unit price multiplied by the unitless quantity), a net price (reflecting any discounts already applied), and a taxable net price (for each tax category) which may be used by the calculation scale look up method to determine its output values.

(2) The calculation scale object.

Output includes:

(1) A look up number that can be compared to the range start values of the scale's range objects in order to determine a range look up result.

(2) A base monetary value to be passed to the range look up result method along with a range look up result object in order to determine a calculation result.

(3) A result multiplier by which the result of the range look up result method should be multiplied in order to arrive at a calculation scale result.

(4) A set of mathematical weights, one per commerce object, that can be used to spread the calculation scale result back over the commerce objects.

(5) An exception is thrown if a conversion of a monetary amount or quantity is required but no such conversion is available.

The calling interface to a range look up result method is:

Input includes:

(1) The currency the calculation should be in.

(2) A calculation range look up result object.

(3) The part of the look up number (produced by the calculation scale look up method) that is applicable to this calculation.

(4) The part of the base monetary value (produced by the calculation scale look up method) that is applicable to this calculation.

Output includes:

(1) the calculation result, which is a monetary value in the specified currency.

(2) An exception is thrown if a result in the specified currency cannot be determined.

According to one aspect of the invention, the steps used to determine a calculation result (which is a monetary amount) for each of a set of commerce objects from a calculation scale are:

1. Start with a zero total result.

2. Call the calculation scale's look up method and pass it the set of commerce objects. If it throws an exception, then throw an exception since no result can be calculated (in the currency of the commerce objects) by this calculation scale.

3. For each of the calculation scale's calculation range objects, in ascending of range start, where the look up number returned by the look up method is greater than or equal to the range start number:

(a) If the currency of the calculation range object, or if the look up number is less than the next such calculation range object, or if the calculation range object's cumulative flag is true, then obtain a calculation range look up result object from the calculation range object and call its range look up result method as follows:

(i) If the currency of the calculation range look up result is unspecified, use that look up result to call the range look up result method.

(iii) If there are several calculation range look up results, each specifying a different currency, then use the one that specifies the currency of the commerce objects to call the range look up result method. If none specify that currency, then use the look up result that can be converted to the currency of the commerce objects and produces the lowest calculation result when the range look up result method is called using that calculation range look up result object.

(b) When calling the range look up result method, pass it the following input information:

(i) The currency of the commerce objects. The calculation result produced by the range look up result method will be in this currency.

(ii) The range look up result object obtained above.

(iii) The part of the look up number that is applicable to the calculation range object. For a non-cumulative range object, this is simply the look up number produced by the calculation scale look up method. For a cumulative calculation range object, this is the minimum range value or this is the least of the lookup number and the range end, minus the range start.

The range end is the range start of the next calculation range object, or infinity if there is none.

(iv) The part of the base monetary value that is applicable to the calculation range object. For a non-cumulative range object, this is simply the base monetary value produced by the calculation scale look up method. For a cumulative calculation range object, this is the least of the base monetary value and the product of the range end multiplied by the unit value, where the unit value is the base monetary value divided by the look up number. Range end is the range start of the next calculation range object, or infinity if there is none.

(c) Multiply the calculation result returned by the range look up result method by the result multiplier returned by the calculation scale look up method. If the calculation range object is cumulative, add the product to the total result. Otherwise, the product replaces the total result.

4. Apportion the total result to each of the commerce objects, in proportion to the set of mathematical weights returned by the calculation scale look up method.

Several examples of calculation scale look up methods (CSL methods) within the scope of the calculation scale framework of the present invention are provided herein.

In general, if a monetary amount or quantity cannot be converted when required, a conversion exception is thrown, indicating that a required conversion is not available. The following examples are provided in the context of a predetermined calculation rule, applicable to the commercial environment in which the calculation scale framework is implemented.

CSL Method Based on Quantity:

This method is typically appropriate for shipping scales. (For example, the charge is determined from the quantity, and spread back to the commerce objects in proportion to their quantity.)

If the unit of measure attribute of the calculation scale is specified, the “look up number” is the sum of the quantities of the order items, converted to the unit of measure specified by the calculation scale, and the mathematical weights are the quantities of the commerce objects. But if the calculation scale does not specify a unit of measure, the “look up number” is the sum of the unitless quantities of the commerce objects and the mathematical weights are their unitless quantities. The “base monetary value” is the sum of their net prices. The “result multiplier” is one.

CSL Method Based on Quantity Spread by Net Price

This method is typically appropriate for discount and shipping scales. (The discount/charge is determined from the quantity, and spread back to the order items in proportion to their net prices.)

If the unit of measure attribute of the calculation scale is specified, the “look up number” is the sum of the quantities of the order items, converted to the unit of measure specified by the calculation scale, and the mathematical weights are the net prices of the order items. But if the calculation scale does not specify a unit of measure, the “look up number” is the sum of the unitless quantities of the commerce objects. The “base monetary value” is the sum of their net prices. The result multiplier is one.

CSL Method Based on Weight:

Often, this method is appropriate for shipping scales. (The charge is determined from the total shipping weight, and spread back to the commerce objects in proportion to their shipping weights.)

The “look up number” is the sum of the shipping weights of the commerce objects, converted to the unit of measure specified by the calculation scale. The “base monetary value” is the sum of the net prices. The “result multiplier” is one. The mathematical weights are the shipping weights.

CSL Method Based on Weight Spread by Net Price

Typically, this method is appropriate for discount and shipping scales. (The discount/charge is determined from the total shipping weight, and spread back to the commerce objects in proportion to their net prices.)

The “look up number” is the sum of the shipping weights of the commerce objects, converted to the unit of measure specified by the calculation scale. The “base monetary value” is the sum of the net prices. The “result multiplier” is one. The mathematical weights are the net prices.

CSL Method Based on Non Discounted Price:

Often, this method is appropriate for shipping scales based on the non discounted price of the order items. In other instances, this method may be useful with other kinds of discounts.

In this implementation, the “look up number” and the “base monetary value” are the sum of the gross prices. The “look up number” is converted to the currency of the calculation scale. The “result multiplier” is one. The mathematical weights are the gross prices.

CSL Method Based on Net Price:

This method is often appropriate for discount and shipping scales based on the (possibly) discounted price.

Both the “look up number” and the “base monetary value” are the sum of the net prices of the commerce objects. The “look up number” is converted to the currency of the calculation scale. The “result multiplier” is one. The mathematical weights are the net prices.

CSL Method Based on Unit Price

Often, this method is appropriate for discount and shipping scales that specify a fixed or maximum charge per item based on each item's unit price. (It is only appropriately applied when the unit prices of the commerce objects are the same.).

Both the “look up number” and the “base monetary value” are the sum of the net prices of the commerce objects, divided by the “result multiplier”. The “look up number” is converted to the currency of the calculation scale. The “result multiplier” is the sum of the unitless quantities. The mathematical weights are the “net prices” each divided by its unitless quantity.

CSL Method Based on Taxable Net Price

This method is often appropriate for sales tax scales. By way of example, this may be used in an environment in which there is ‘no tax on meals under $4.00’.

Both the “look up number” and the “base monetary value” are the sum of the taxable net prices of the commerce objects. The “look up number” is converted to the currency of the calculation scale. The “result multiplier” is one. The mathematical weights are the taxable net prices.

CSL Method Based on Taxable Unit Price:

This calculation scale look up method is appropriate for “per item” sales tax scales, where the tax depends on the unit price of each item (For example, there may be a tax scale in which no tax is levied on children's shoes priced below $30.00.) This method may only be implemented when the unit prices of the commerce objects are the same.

Both the “look up number” and the “base monetary value” are the sum of the taxable net prices of the order items, divided by the “result multiplier”. The “look up number” is converted to the currency of the calculation scale. The “result multiplier” is the sum of the unitless quantities. The mathematical weights are the taxable net prices each divided by its unitless quantity.

It will be understood that there may be other calculation scale look up methods which may be implemented in the commercial environments appropriate to those circumstances.

Furthermore, the present invention, provides various range look up result (RLR) methods which may be implemented, according to the particular circumstances of the commercial environment in which the method or system of the invention is implemented.

RLR Method Based on Fixed Amount:

If the currency of the range look up result object is not the specified input currency, throw an exception since a result in the specified currency cannot be obtained. Otherwise, return a monetary amount that is the range look up result in that currency.

RLR Method Based on Per Unit Amount:

If the currency of the range look up result object is not the specified input currency, throw an exception since a result in the specified currency cannot be obtained. Otherwise, return a monetary amount that is the product of the range look up result multiplied by the part of the “look up number” that is applicable to this calculation (one of the input parameters).

RLR Method Based on Percentage:

Return a monetary amount that is the range look up result divided by 100 and then multiplied by the part of the “base monetary value” that is applicable to this calculation (one of the input parameters).

It will be understood that other range look up result (RLR) methods may also be appropriate, depending on the circumstances arising in the particular commercial environment in which the method or system of the invention may be implemented.

In another aspect, the invention provides a computer product. The computer product may be recorded on a CD-ROM, electromagnetic media, such as for example, a magnetic floppy disk, a hard drive, or other suitable media. The computer product may be programmed to implement one or more of the methods of the present invention.

In another aspect, the invention provides another embodiment of a computer product. The computer program product is provided for use with a computer system in an electronic commerce environment comprising a computer network, the electronic commerce environment defining a calculation rule, and a set of commerce objects being defined by the electronic commerce environment, the computer program product comprising:

a recording medium,

means, recorded on the recording medium, for providing a calculation scale look up interface to return a result multiplier and a set of mathematical weights corresponding to the set of commerce objects;

means, recorded on the recording medium, for providing a range look up result interface to return a calculation result;

means, recorded on the recording medium, for providing a multiplication product of the calculation result and the result multiplier;

means, recorded on the recording medium, for providing a total result by adding the multiplication product to a previously determined sum of multiplication products, in a cumulative environment defined by the calculation rule, or, replacing the previously determined multiplication product in a non cumulative environment defined by the calculation rule;

and means, recorded on the recording medium, for apportioning the total result to the set of commerce objects in proportion to the set of mathematical weights.

It will be appreciated by those skilled in the art that the computer program can be stored in storage or transmitted as a signal, such as a modulated carrier signal for use in a computer system, or on a network such as the Internet for use in a compiler system.

Further and other embodiments of the present invention will become more apparent to those skilled in the art in view of the appended drawings and the more detailed description provided below.

### BRIEF DESCRIPTION OF THE DRAWINGS

FIG. 1 is a schematic representation, in a flow chart format, of one embodiment of the calculation scale framework of the present invention.

FIG. 2 is a schematic representation, in a data flow diagram format, of one embodiment of the calculation scale framework of the present invention.

FIG. 3 is a schematic representation of one embodiment in which the method of the invention is used to provide invoice line items for shipping charges based on a fixed rate plus a charge per unit of shipping weight.

FIG. 4 is a schematic representation of one embodiment of the invention in which the method of the invention is used to provide invoice line items for tax exempt items individually priced below $30.00 (Cdn dollars).

FIG. 5 is a schematic representation of one embodiment of the invention in which the method of the invention is used to provide invoice line items for taxable items individually priced above a minimum taxable threshold of $30.00 (Cdn dollars) per unit.

### DETAILED DESCRIPTION OF THE INVENTION

There are many examples of the methods provided by the calculation scale framework in accordance with the method of the present invention. Examples of the methods provided by the preferred embodiments are described further below.

In general, the calculation scale framework is established within an environment defined by a calculation rule. By way of example, the calculation rule may be established as a matter of commercial choice. Shipping charges are one such example. Typical shipping charges incurred by an e-commerce entity may be determined according to a predetermined tariff. The terms of the tariff will in turn affect the particular steps to be used in the context of that predefined environment. Another example, may involve a particular statutory scheme in which taxation rates are predefined according to the requirements of the appropriate government body. There are many other possible examples of the kinds of calculation rules which may be established by the particular commercial environment in which the method of the invention may be used.

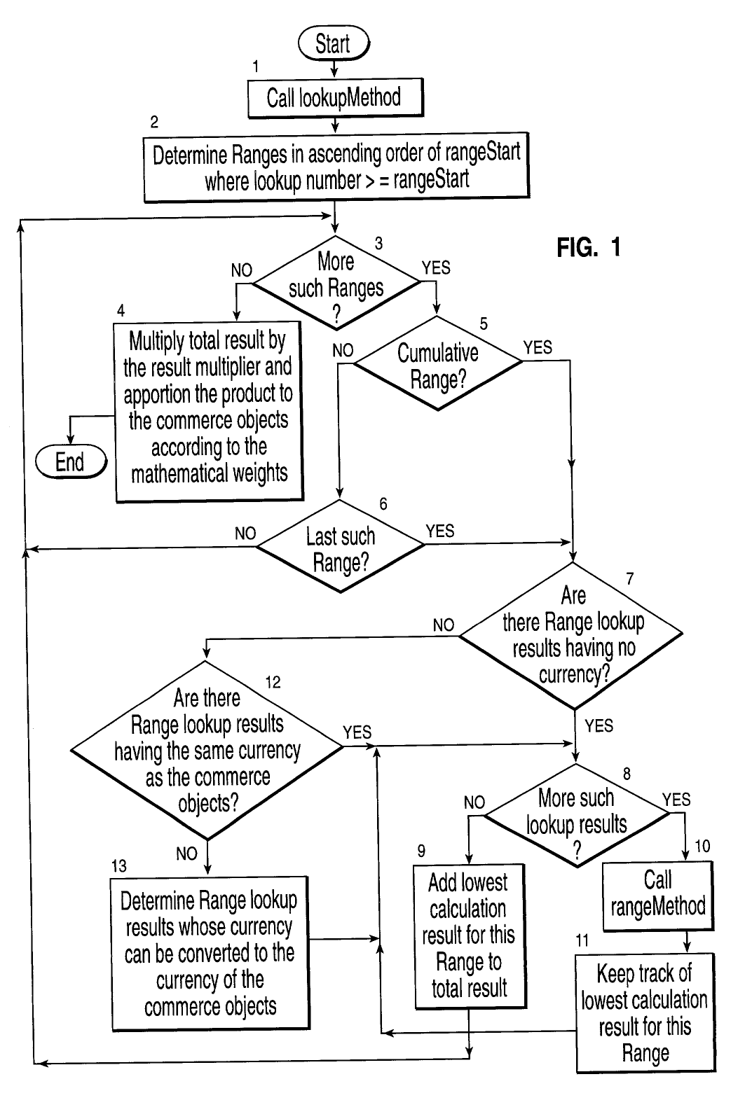

With reference to FIG. 1, a schematic representation is provided of one embodiment in which generic steps are provided within a calculation scale framework. For the purposes of this generic example, the particulars of the calculation rules are not described. However, it is understood that in particular inplementations, the calculation rules will be predetermined according to the corresponding environment. A series of steps are depicted and for ease of reference, the paths between various numbered steps are depicted with arrows. However, it will be understood that the numbering is provided to simplify the description of the steps although the numbering does not necessarily determine the necessary order of the process steps in any particular implementation. In addition, it will be understood that in connection with certain decision points within the method, logic paths are designated with either ‘N’ for ‘no’ decisions or ‘Y’ for ‘yes’ decisions in response to the particular questions posed within the corresponding decision point.

A user starts the generic method at the ‘start’ point depicted within the flow chart of FIG. 1. The user in step 1 calls the look up method in view of the particular line item problem at hand. In step 2, the user determines the ranges in ascending order of range start values.

According to this method, the look up number will be either equal to or greater than the range start value called up.

The look up number is considered in step 3 to determine whether there are more ranges to be considered within the steps of the method. If there are no more of such ranges, the user proceeds to step 4 , in which the total result provided by the method is multiplied by the result multiplier generated by the method. The product of that calculation is then apportioned between the commerce objects according to predetermined mathematical weights. This represents the end of the calculation scale method operation where there are no more of such ranges to consider.

If in step 3, it is determined that there are more such ranges, the user proceeds to step 5. The decision point in step 5 is used to determine whether the range is cumulative. Where the answer is yes at this decision point, the user proceeds to step 7. Where the answer at this decision point is no, the user proceeds to step 6 and the corresponding decision point at step 6. In step 6, a determination is made whether the range value is the last such range object. If the answer at step 6 is no, the user proceeds back to step 3. However, as noted above, a yes answer at step 5 or step 6, leads to the decision point at step 7.

The decision point at step 7 is used to determine whether there are range look up results having no currency. A yes answer at step 7 leads the path to step 8 and the corresponding decision point. A no answer at step 7 leads the path to step 12 and the corresponding decision point at step 12. For ease of consideration, a yes answer at the decision point in step 7 is considered first, leading to step 8.

In step 8, a determination is made whether there are more such look up results to consider. If the answer at this decision point is no, the path proceeds to the decision point at step 9. In step 9, the lowest calculation result for this range is added to the total result. After this determination is made, the path proceeds back to step 3.

However, if in step 8, it is determined that there are more such look up results, the path proceeds to step 10. In step 10, the range method is called. In turn, the path proceeds to step 11 and the corresponding method step. In step 11, the user keeps track of the lowest calculation result for this range. Upon performing this step, the path returns to step 8 and the corresponding decision point in step 8.

With reference to step 7 and other instances in which there is a determination that there are no range look up results having no currency, the path proceeds to the decision point in step 12. In step 12, it is determined whether there are range look up results having the same currency as the commerce objects. If the answer at this decision point is yes, the path proceeds to step 8. If the answer is no at decision point 12, the path proceeds to step 13.

In step 13, the method determines those range look up results whose currency values can be converted to the currency of the commerce objects passed into the calculation scale method input. Upon completion of this step, the path proceeds to step 8 and the corresponding decision point therein.

The user path is continued until the various determinations and calculations lead the user path to step 4 and the corresponding end of the method's calculation path depicted in FIG. 1.

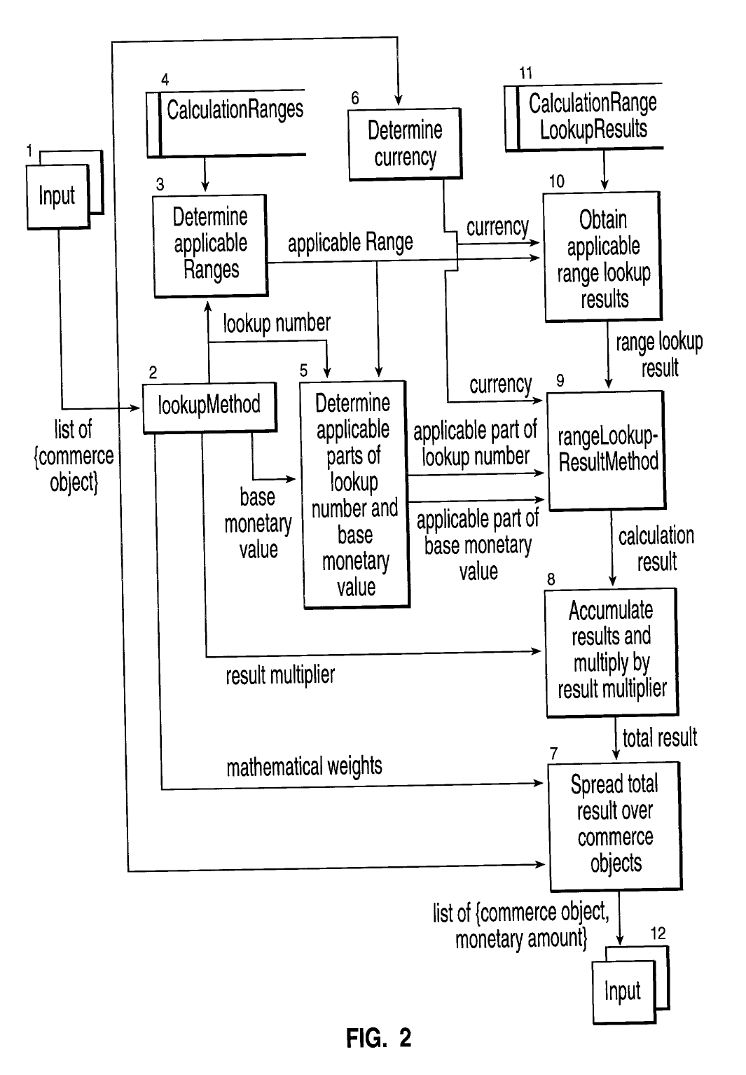

FIG. 2 depicts in schematic form a data flow path in the context of a method of one embodiment of the present invention. An input comprises a list of commerce objects and upon proceeding through the data flow steps of the method, an output is provided in which a list of commerce objects is provided along with corresponding monetary amounts calculated according to the appropriate methodology, within the context of the appropriate calculation rule for that environment. A series of source points 1 to 12 inclusive are depicted within this schematic diagram. However, it will be understood that the numbering sequence does not impose or require that the data flow according to the order or sequence of the numbers as used in this diagram. The numbering scheme was selected for ease of description rather than to imply a necessary order for the flow of data within the method as illustrated.

The list of commerce objects from source point I are used to determine currency at point 6, to determine a total result spread over the commerce objects at point 7, and to call the look up method at point 2.

The look up method at point 2 is utilized to generate a look up number (to be used at points 3 and 5), a base monetary value (to be used at point 5), a result multiplier (to be used at point 8) and a set of mathematical weights to be used (in conjunction with the list of commerce objects) at point 7 to spread a total result over the list of commerce objects.

The look up number determined at point 2 is used to determine applicable ranges at point 3 and to determine the applicable part of the look up number and the base monetary value at point 5. As noted, the look up number determined at point 2 is used at point 3, along with the identified calculation range to determine the applicable range for the commerce object under consideration. The applicable range value from point 3 is used at points 5 and 10 respectively.

With reference to point 5, the inflowing data values for base monetary value and the look up number (from point 2), and the applicable range (from point 3) are used at point 5 to determine the applicable part of the look up number and base monetary value to be used at point 9.

With reference to previously noted point 6, the list of commerce objects are provided to point 6 to determine the currency of those values. The currency data from point 6 is provided to point 10 and to point 9. At point 10, a set of predetermined calculation range look up results, currency data from point 6 and the applicable range from point 3 are utilized to obtain applicable range look up results. A range look up result determined at point 10 is used in the range look up result method illustrated at point 9 as described below.

The range look up result (determined at point 10), the currency (from point 6), the applicable parts of the look up number and the base monetary value (from point 5) are utilized at point 6, within the range look up result method, to determine the calculation result.

The calculation result from point 9, and the result multiplier from the look up method at point 2 are used at point 8 to accumulate results and multiply the accumulated values by the result multiplier. Upon completion of this step, the total result is determined and passed to point 7. As previously noted, the total result (from point 8), the mathematical weights (from point 2), and the list of commerce objects (from Input point 1) are used to spread the total result over the commerce objects. Upon completion of this step at point 7, a list of commerce objects and corresponding monetary amounts is provided as an output at point 12. Accordingly, a desired line item (consisting of a list of commerce object and monetary amount) may be provided for the particular commercial environment under consideration.

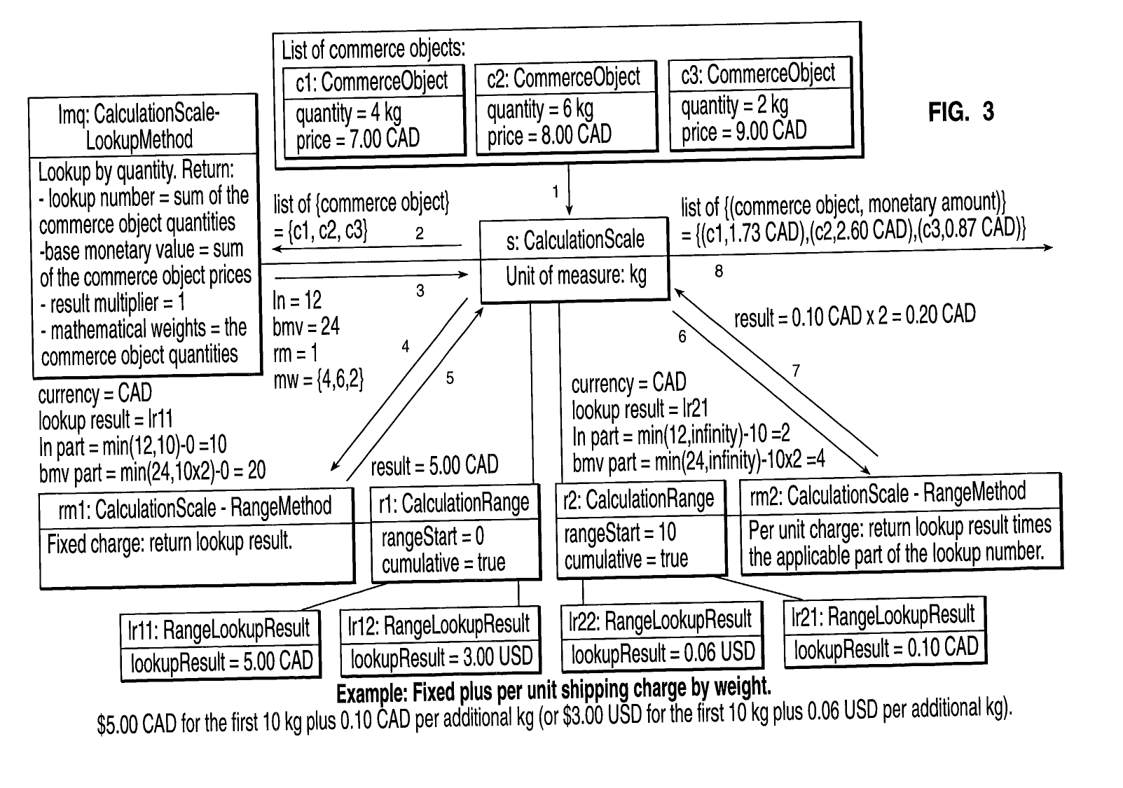

FIG. 3 is a schematic representation of an embodiment of the present invention in which the calculation scale framework is used to calculate shipping charges based on a system in which shipping rates are calculated at a fixed rate per unit (under a threshold limit) plus an added shipping charge per unit of weight above the predetermined limit. In this example, the predetermined calculation rule provides that when the currency of the commerce objects is CAD, the shipping rate is determined at a charge of $5.00 ($Cdn) for the first 10 kg, plus $0.10 ($Cdn) for each additional kg of shipped weight. Again, for the purposes of this example, the predetermined calculation rule also provides that when the currency of the commerce objects is USD, the shipping rate is determined at a charge of $3.00 ($US) for the first 10 kg, plus 0.06 ($US) for each additional kg of shipped weight. For the purposes of this example, assume that the user wishes to determine the per unit shipping cost to be allocated to the various commerce objects recognizing that the first commerce object has a weight of 4 kg, the second object has a weight of 6 kg and the third commerce object has a weight of 2 kg.

In this example, a list of three commerce objects, c1, c2, c3 are provided. Commerce object c1 corresponds to a quantity of 4 kilograms, priced at $7.00 ($Cdn). Commerce object c2corresponds to a quantity of 6 kg priced at $8.00 ($Cdn). Commerce object c3 corresponds to a quantity of 2 kilograms priced at $9.00 ($Cdn).

The commerce objects c1, c2, c3 are passed to the calculation scale to determine if the appropriate unit of measure is provided. In this case, the unit of measure is kg (kilograms). The list of commerce objects {c1, c2, c3} is passed to the calculation scale look up method in step 2. According to the steps of that method, the user looks up the input by quantity. The user obtains a return of the following values in step 3:

(a) a look up number which equals the sum of the commerce object quantities. In this example, the look up number (In) equals 12. [Calculated as 4+6+2 kg=12 kg.]

(b) a base monetary value which equals the sum of the commerce object prices. In this example, the base monetary value (bmv) equals 24. [Calculated as $7.00+$8.00+$9.00=$24.]

(c) the result multiplier (rm) which in this example equals 1.

(d) the mathematical weights (mw) which equals the respective object quantities. The mathematical weights are {4,6,2} respectively.

With reference to the other steps depicted within FIG. 3, it will be apparent that two range iterations will be utilized to arrive at the final determination according to the method of this invention. A first calculation range of r1 is obtained. Calculation range r1 has a corresponding range start value of 0. The range method example is cumulative in this case as depicted in the illustrated case. (That is, a further iteration will be required for the remaining 2 kg of weight corresponding to a second range, as will be seen further below.)

In step 4, the data is passed to the calculation scale range method. According to this example, the currency=CAD, the look up number part (In part) is the lesser of 12 and 10, minus zero, in other words 10, and the base monetary value part (bmv part) is the lesser of 24 and the product of 10 and 2, minus zero, in other words 20. A fixed charge look up result (Ir11) of $5.00 is returned at step 5 for the first 10 kg of shipping weight. [Ir11=$5.00 CAD]. In this example, lookup result Ir12 is also available when Ir12 is $3.00 USD, but is not used since the currency of the commerce objects is not USD.

The second calculation range, r2, is determined with a range start value=10 (corresponding to the end of the first pricing range set at 10 kg.) The calculation range for the results of the two weight ranges is cumulative, as indicated in the example.

In step 6, the currency=CAD, the look up number part (In part) is 2 (calculated as the lesser of 12 and infinity, minus 10, in other words 2) and the base monetary value is 4 (calculated as the lesser of 24 and infinity, minus the product of 10 and 2, in other words 4). A range look up result (Ir21) is obtained with a corresponding value of $0.10 CAD. Since a currency conversion is available in this example, a converted look up result in USD is provided, Ir22=$0.06 USD. By calling the calculation scale range method (rm2), a result of $0.20 CAD is returned. The second iteration of the calculation scale range method (rm2) is based on an iteration corresponding to a per unit charge of $0.10 CAD per unit of weight (per kg). In this example, the user returns the look up result multiplied by the applicable part of the look up number. [The result is calculated as $0.10 CAD×2=$0.20 CAD.]

According to the method of the present invention, the cumulative shipping charge of $5.00+$0.20=$5.20 CAD is returned. The list of commerce objects is then weighted according to the mathematical weights in this example. For the first commerce object, c1, the weighted shipping cost=(4+12)×$5.20 CAD=$1.73 CAD. The weighted shipping costs for commerce objects c2, c3 are returned as $2.60 CAD and $0.87 respectively (calculated for c2 as (6 +12)×$5.20 CAD=$2.60 CAD, and for c3 as (2.12)×$5.20 CAD=$0.87 CAD.)

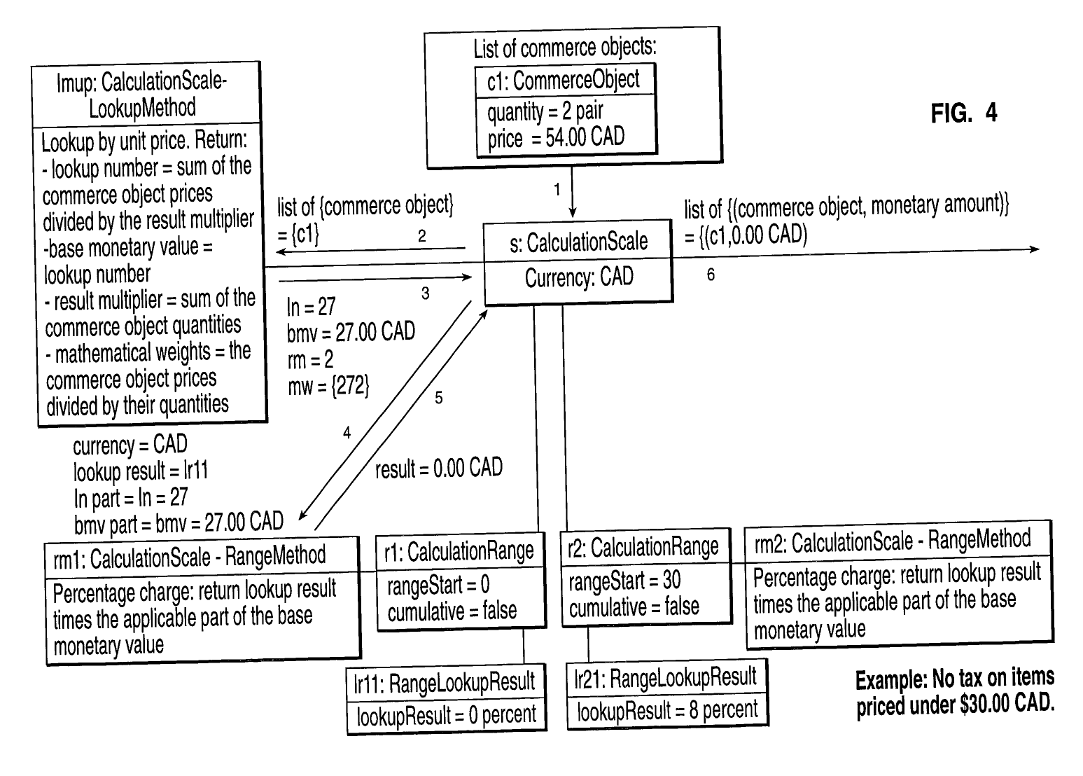

In the example of FIG. 4, an embodiment of the invention is utilized in association with a commerce object provided in the context of a statutory scheme in which no tax is payable on items priced below $30.00 per unit. Assume that under this statutory scheme, a tax rate of 8% is applied to items priced from starting point of $30.00 and applying to higher priced items. This example will illustrate how the corresponding invoice line item will be calculated for the pretax commerce object values as provided. In this instance, a list of commerce objects is comprised of commerce object c1. The commerce object corresponds to 2 pairs of shoes, for a total price of $54.00 CAD. The list of commerce objects is passed to the calculation scale s. The currency, as indicated, is in Canadian dollars, CAD.

In step 2, the list of commerce objects is passed to the calculation scale look up method. In the calculation scale look up method, the user looks up the desired result by referring to the unit price. The calculation scale look up method returns the following values in step 3:

(a) a look up number (In) which is equal to the sum of the commerce object prices divided by the result multiplier. [In this instance, the look up number In=54÷2=27.]

(b) a base monetary value (bmv) which in this case is the look up number (In). (c) a result multiplier (rm) which in this instance is the sum of the commerce object quantities. [rm=2.]

(d) the mathematical weights (mw) which are in this case, the commerce object prices divided by their quantities. [mw=54÷2 =27.]

In step 4, the calculation range method (rm1) is called. The range start value for the calculation range is equal to zero [range start=0.] In this example, the range is not cumulative, in the context of the statutory scheme and the applicable calculation rule. A range look up result (Ir11) is called, showing that Ir11=0 percent (for the applicable tax rate).

With reference again to the calculation range look up method, (rm1), the user looks up the percentage charge (i.e., look up percentage charge). The user then returns a look up result times the applicable part of the base monetary value. In this example, the corresponding values generated through the calculation scale range method are as follows:

(a) currency=CAD

(b) the look up result=Ir11 (returned as Ir11=0)

(c) the look up number part (In part)=27

(d) the base monetary value part=bmv=$27.00 CAD.

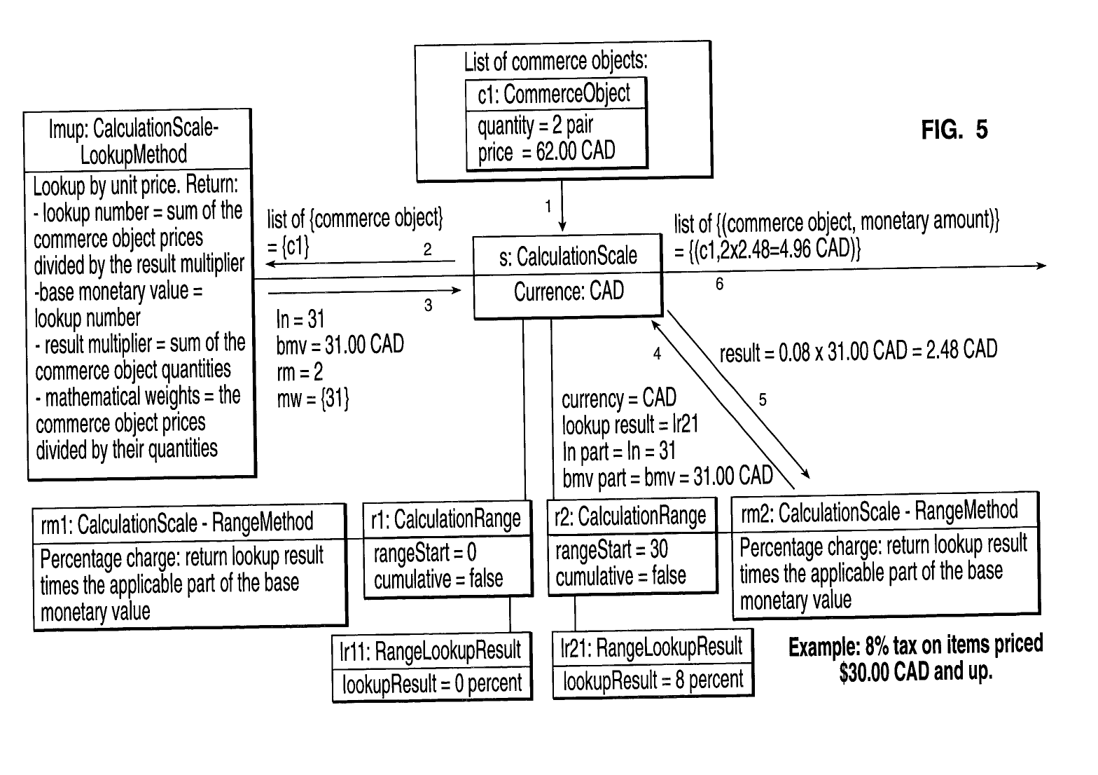

The calculation scale range method (rm 1) returns a result=$0.00 CAD. [The result is calculated as Ir11(0.00)×$27.00=$0.00 CAD.] A second iteration is not required in this instance since there are no corresponding calculations for units with prices within a range start value starting at $30 (r2). Accordingly, there is no iteration of tax calculations for the calculation range (r2), the calculation scale range method (rm2) or the range look up result (Ir21) for this particular example. However, such an example is illustrated below in association with FIG. 5 as described further below.

In FIG. 5, an embodiment is illustrated in the context of the same statutory scheme as described in association with FIG. 4. That is, an 8% tax (such as for example, a sales tax) is applied to articles individually priced at $30.00 CAD or more per item. In this particular example, the commerce object is c1; and c1 corresponds to a quantity of 2 pairs (of, for example, children's shoes) for a total price of $62.00 CAD. The list of commerce objects {c1} is passed to the calculation scale look up method in step 2. The user accesses the look up by unit price. The calculation scale look up method returns the following values in the context of this example:

(a) a look up number (In) which is equal to the sum of the commerce object prices divided by the result multiplier (rm). (In this example, the In=$64÷2=31.)

(b) a base monetary value (bmv) which is equal to the look up number (In).

(c) a result multiplier (rm) which is equal to the sum of the commerce object quantities (rm=2).

(d) the mathematical weights (mw) are equal in this example to the commerce object prices divided by their quantities. (In this example, mw={31}=(64÷2=31).)

In FIG. 5, an iteration is called for calculation range (r2) based on a range start=30 (corresponding to the starting point for applicable taxation in this example.) The operation is not cumulative, as noted in the context of this example. The user returns a range look up result (Ir21)=8 per cent.

The user calls the calculation scale range method (rm2) in step 6. In step 6, the following values are obtained:

(a) the currency=CAD

(b) the look up result (Ir)=Ir21=8 percent.

(c) the look up number part (In part)=In=31 in this example.

(d) the bmv part=bmv=$31.00 CAD in this example.

Based on these values, the user, accessing the calculation scale range method (based on a percentage charge) will return a look up result times the applicable part of the base monetary value. (In this instance, the result is calculated as result=0.08×$31.00 CAD=$2.48 CAD.) A result of $2.48 CAD is returned in step 7. In step 8, a list of commerce objects and monetary amounts is provided. (The list of {(commerce object, monetary amount)}={(c1, 2×$2.48=$4.96 CAD)} where 2 is the result multiplier rm returned by the calculation scale lookup method lmq). It will be appreciated that the foregoing are only a few of the embodiments which fall within the scope of the present invention. Other embodiments which fall within the scope of the present invention. Other embodiments of the invention will be apparent to those persons skilled in the art upon a review of the entire specification, including the description herein. It is intended that the present invention shall include the variations and modifications of the other embodiments that will be apparent to those skilled in the art as a result thereof.

It will be appreciated that the foregoing are only a few of the embodiments which fall within the scope of the present invention. Other embodiments of the invention will be apparent to those persons skilled in the art upon a review of the entire specification, including the description herein. It is intended that the present invention shall include the variations and modifications of the other embodiments that will be apparent to those skilled in the art as a result thereof.

The embodiments of the invention in which an exclusive property or privilege is claimed are defined as follows:

1. A method of providing a calculation scale framework for use in an electronic commerce environment comprising a computer network, the electronic commerce environment defining a calculation rule, and a set of commerce objects being defined by the electronic commerce environment, the method comprising:
providing a calculation scale comprising calculation ranges, each said calculation range being either cumulative or non-cumulative and having an associated range start number, an optional currency attribute, which if present specifies the currency of the range start numbers, and an optional unit of measure attribute, which is present specifies the unit of measure for the range start numbers;
providing a calculation scale look up interface to return a look up number, a base monetary value, a result multiplier and a set of mathematical weights corresponding to the set of commerce objects;
providing a range look up result interface to return a calculation result;
providing a multiplication product of the calculation result and the result multiplier;
providing a total result by adding the multiplication product to a previously determined sum of multiplication products, for cumulative calculation ranges or, replacing the previously determined multiplication product for noncumulative calculation ranges;
and apportioning the total result to the set of commerce objects in proportion to the set of mathematical weights.

2. The method as claimed in claim 1, the method comprising:
passing the set of commerce objects, the calculation rule, and the calculation scale to the calculation scale look up interface.

3. The method as claimed in claim 2, comprising passing a currency, a calculation range look up result, an applicable part of a look up number, and an applicable part of a base monetary value.

4. The method of claim 3, wherein the applicable part of the look up number is returned by the calculation scale look up interface.

5. The method of claim 4, wherein the applicable part of the base monetary value is returned by the calculation scale look up interface.

6. The method of claim 5, wherein the calculation scale look up interface returns parameters comprising:
a look up number for comparison to a predetermined set of range start values;
the base monetary value;
the result multiplier;
the set of mathematical weights; and
an exception if a required conversion defined by the electronic commerce environment is not available.

7. The method of claim 6, wherein the range look up result interface returns an exception if a calculation result is not available in a currency specified by the electronic commerce environment.

8. The method of claim 7, wherein the total results are apportioned by one or more of a group of parameters having quantity, quantity spread by net price, weight, weight spread by net price, non discounted price, net price, unit price, taxable net price, and taxable unit price.

9. The method of claim 8, wherein the range look up result interface returns the calculation result calculated from one or more in a set of parameters having a fixed amount, a per unit amount, and a percentage.

10. A computer program product for use with a computer system in an electronic commerce environment comprising a computer network, the electronic commerce environment defining a calculation rule, and a set of commerce objects being defined by the electronic commerce environment, the computer program product comprising:
a recording medium,
means, recorded on the recording medium, for providing a calculation scale look up interface to return a result multiplier and a set of mathematical weights corresponding to the set of commerce objects;
means, recorded on the recording medium, for providing a range look up result interface to return a calculation result;
means, recorded on the recording medium, for providing a multiplication product of the calculation result and the result multiplier;
means, recorded on the recording medium, for providing a total result by adding the multiplication product to a previously determined sum of multiplication products, in a cumulative environment defined by the calculation rule, or, replacing the previously determined multiplication product in a non cumulative environment defined by the calculation rule;
and means, recorded on the recording medium, for apportioning the total result to the set of commerce objects in proportion to the set of mathematical weights.

11. The computer product of claim 10, wherein the recording medium is one of a group of magnetic recording media having a computer disk, a CDROM, and a hard drive.

12. The computer product of claim 11, wherein the recording medium comprises means for passing the set of commerce objects and a predetermined set of calculation range objects to the calculation scale look up interface.

13. The computer product of claim 12, wherein the recording medium comprises means for passing a set comprising a calculation range look up result, an applicable part of a look up number, and an applicable part of a base monetary value.

14. The computer product of claim 13, wherein the recording medium comprises means for returning the applicable part of the look up number from the calculation scale look up interface.

15. The computer product of claim 14, wherein the recording medium comprises means for returning the applicable part of the base monetary value from the calculation scale interface.

16. The computer product of claim 15, wherein the recording medium comprises means for returning from the calculation scale look up interface parameters comprising:
a look up number for comparison to a predetermined set of range start values;
the base monetary value;
the result multiplier;
the set of mathematical weights; and
an exception if a required conversion defined by the electronic commerce environment is not available.

17. The computer product of claim 16, wherein the recording medium comprises means for returning an exception from the range look up result interface if a calculation result is not available in a currency specified by the electronic commerce environment.

18. The computer product of claim 17, wherein the recording medium comprises means for returning, from the calculation scale look up interface, total results apportioned by one or more of a group of parameters having quantity, quantity spread by net price, weight, weight spread by net price, non discounted price, net price, unit price, taxable net price, and taxable unit price.

19. The computer product of claim 18, wherein the recording medium comprises means for returning, from the range look up result interface, the calculation result calculated from one or more in a set of parameters having a fixed amount, a per unit amount, and a percentage.

20. The computer program product of claim 10 wherein said computer readable code means comprises a computer readable signaland said medium comprises a computer readable signal-bearing medium.

21. The computer program product of claim 20 wherein said medium is a recordable data storage medium.

22. The product of claim 20 wherein said medium is a modulated carrier signal.

23. The product of claim 22 wherein said signal is a transmission over a network.

24. A computer program comprising computer program code means adapted to perform all the steps of claim 1 when said program is run on a computer system
